(19) United States
(12) Patent Application Publication
(10) Pub. No.: US 2026/0180349 A1
(43) Pub. Date: Jun. 25, 2026

(54) PROTECTION CIRCUIT AND PROTECTION METHOD FOR SECONDARY BATTERY

(71) Applicant: NISSHINBO MICRO DEVICES INC., Tokyo (JP)

(72) Inventors: Takuya Hirasawa, Ikeda-shi, Osaka (JP); Masashi Oshima, Takarazuka-shi, Hyogo (JP)

(21) Appl. No.: 18/839,718

(22) PCT Filed: Jul. 27, 2023
(86) PCT No.: PCT/JP2023/027603

§ 371 Date: Aug. 19, 2024

(51) Int. Cl. H02J 7/60

(52) U.S. Cl. CPC H02J 7/663

(57) ABSTRACT

The protection circuit for a secondary battery of the disclosure protects an assembled battery by cutting the charging path to or the discharge path from the assembled battery including secondary batteries connected in series. The protection circuit for the secondary battery includes: a first detector circuit for at least one of an overcharge detector circuit that detects overcharge to secondary batteries and an over-discharge detector circuit that detects over-discharge from the secondary batteries, the first detector circuit outputting a first detection signal at the time of detection; a second detector circuit that detects disconnection between the secondary batteries and the protection circuit and outputs a second detection signal upon detection; and a protection control circuit that stops cutting the charging or discharging path based on the first and second detection signals from the time the protection circuit is activated until the disconnection is no longer detected.

### TECHNICAL FIELD

The present invention relates to a protection circuit and a protection method for a secondary battery.

### BACKGROUND ART

Conventionally, a protection circuit for a secondary battery for preventing overcharge or overdischarge by monitoring a voltage for the secondary battery has been put into practical use.

FIG. 7 is a block diagram illustrating a configuration example of a protection circuit 101 for a secondary battery according to a conventional example 1 and its peripheral circuits. Referring to FIG. 7, the protection circuit 101 for the secondary battery is provided for an assembled battery 2A that charges by supplying power from a charging apparatus 3 to the assembled battery 2A including two secondary batteries B11 and B12 connected in series via terminals T21 and T22, or supplies power from the assembled battery 2A to a load 3 (reference numeral 3 denotes, for example, a load of an electronic apparatus or a charging apparatus) via the terminals T21 and T22. The protection circuit 101 includes resistors R11 and R12 and capacitors C11 and C12 for measuring the battery voltages of the secondary batteries B11 and B12. In this case, the protection circuit 101 for the secondary battery monitors the battery voltage of each of the secondary batteries B11 and B12, monitors the output voltage using the resistor R13 connected to the terminal T22, and turns on or off MOS transistors Q11 and Q12 which are charge and discharge switches based on the monitored voltage to control overcharge or overdischarge of the secondary batteries B11 and B12.

In addition, FIG. 8 is a block diagram illustrating a configuration example of a protection circuit 102 for a secondary battery according to a conventional example 2 and its peripheral circuits. Referring to FIG. 8, the protection circuit 102 for the secondary battery is a protection circuit for an assembled battery 2B including three secondary batteries B21 to B23 connected in series that charges by supplying power from the charging apparatus 3 to the assembled battery 2B via fuses F1 and F2 and the terminals T21 and T22, or supplies power from the assembled battery 2B to the load 3 via the fuses F1 and F2 and the terminals T21 and T22. The protection circuit 102 includes resistors R20 to R23 and capacitors C20 to C23. In this case, each of the resistor R21 and the capacitor C21, the resistor R22 and the capacitor C22, and the resistor R23 and the capacitor C23 is a low-pass filter for voltage measurement, and each of the resistor R20 and the capacitor C20 is a low-pass filter for suppressing power supply voltage fluctuation. In addition, the protection circuit 102 for the secondary battery monitors the battery voltages of the secondary batteries B21 to B23, and based on the monitored voltage, the fuses F1 and F2 are fused by heat generated by the heater resistor R1 via the MOS transistor Q1 which is a switching transistor to control to stop charging and discharging from the secondary batteries B21 to B23.

### PRIOR ART DOCUMENT

### Patent Document

Patent Document 1: Japanese patent No. JP7101851B2

### SUMMARY OF THE INVENTION

### Problems to be Solved by the Invention

In the protection circuit for the secondary battery according to the conventional example 2, if erroneous detection occurs even once, it cannot be reused due to fusing of the fuses F1 and F2. Therefore, it is necessary to prevent erroneous detection from occurring even on the way of connections between a plurality of secondary batteries and the terminals of the protection circuit.

In addition, as in the protection circuit for the secondary battery according to the conventional example 1, when charging and discharging are controlled by turning on or off the switching transistor or the like without using the fuses F1 and F2, the erroneous detection does not cause an irreversible reaction, but it is desirable that but malfunction itself does not occur.

In the protection circuit for the secondary battery that prevents erroneous detection on the way of the connections between the secondary battery and the protection circuit at the time of startup based only on the voltage as described above, there is a possibility that erroneous detection cannot be prevented when only an intermediate terminal is not connected. In addition, when a function of performing protection by detecting disconnection between the secondary battery and the protection circuit and prohibiting charging and discharging is implemented, there is such a problem that a state in the middle of connection is determined as a disconnection state.

An object of the present disclosure is to provide a protection circuit and a protection method for a secondary battery that solve the above problems, and achieve both erroneous detection on the way of connections at the time of startup and a protection function due to disconnection detection after connection.

### Solutions to the Problems

According to the first aspect of the disclosure, there is provided a protection circuit for a secondary battery configured to protect an assembled battery including a plurality of secondary batteries connected in series by cutting a charging path to the assembled battery or a discharging path from the assembled battery. The protection circuit for the secondary battery includes the first and second detector circuits, and a protection control circuit. The first detector circuit is provided for at least one of an overcharge detector circuit configured to detect overcharge of the plurality of secondary batteries and an overdischarge detector circuit configured to detect overdischarge from the plurality of secondary batteries, and the first detector circuit is configured to output a first detection signal at a time of detection of the overcharge or the overdischarge. The second detector circuit is configured to detect disconnection between the plurality of secondary batteries and the protection circuit, and output a second detection signal at a time of detection of the disconnection. The protection control circuit is configured to stop cutting of the charging path or the discharging path based on the first and second detection signals until the disconnection is no longer detected after startup of the protection circuit.

In addition, according to the second aspect of the disclosure, there is provided a protection circuit for a secondary battery configured to protect an assembled battery including a plurality of secondary batteries connected in series by cutting a charging path to the assembled battery or a discharging path from the assembled battery. The protection circuit for the secondary battery includes the first and second detector circuits, and a protection control circuit. The first detector circuit is provided for at least one of an overcharge detector circuit configured to detect overcharge of the plurality of secondary batteries and an overdischarge detector circuit configured to detect overdischarge from the plurality of secondary batteries, and the first detector circuit is configured to output a first detection signal at a time of detection of the overcharge or the overdischarge. The second detector circuit is configured to detect disconnection between the plurality of secondary batteries and the protection circuit, and output a second detection signal at a time of detection of the disconnection. The protection control circuit is configured to stop a detection operation of the first detector circuit and stop cutting of the charging path or the discharging path based on the second detection signal until the disconnection is no longer detected after startup of the protection circuit.

### Effects of the Invention

Therefore, according to the protection circuit for the secondary battery of one aspect of the present disclosure, by using the determination of the presence or absence of the disconnection at the time of startup of the protection circuit for the determination of whether or not the connection is in progress, it is possible to achieve both the prevention of erroneous detection on the way of the connections at the time of startup and the protection function by the disconnection detection after the connection.

### BRIEF DESCRIPTION OF THE DRAWINGS

FIG. 1 is a block diagram showing a configuration example of a protection circuit 1 for a secondary battery according to an embodiment 1 and its peripheral circuits.

FIG. 2 is a block diagram illustrating a configuration example of a protection circuit 1A for a secondary battery according to an embodiment 2 and its peripheral circuits.

FIG. 3 is a block diagram illustrating a configuration example of a protection circuit 1B for a secondary battery according to an embodiment 3 and its peripheral circuits.

FIG. 4 is a block diagram illustrating a configuration example of a protection circuit 1C for a secondary battery according to an embodiment 4 and its peripheral circuits.

FIG. 5 is a block diagram illustrating a detailed configuration example of disconnection detector circuits 21 and 22 of FIG. 1.

FIG. 6 is a flowchart illustrating a protection process executed by a protection circuit 1 for the secondary battery of FIG. 1.

FIG. 7 is a block diagram illustrating a configuration example of a protection circuit for a secondary battery according to a conventional example 1 and its peripheral circuits.

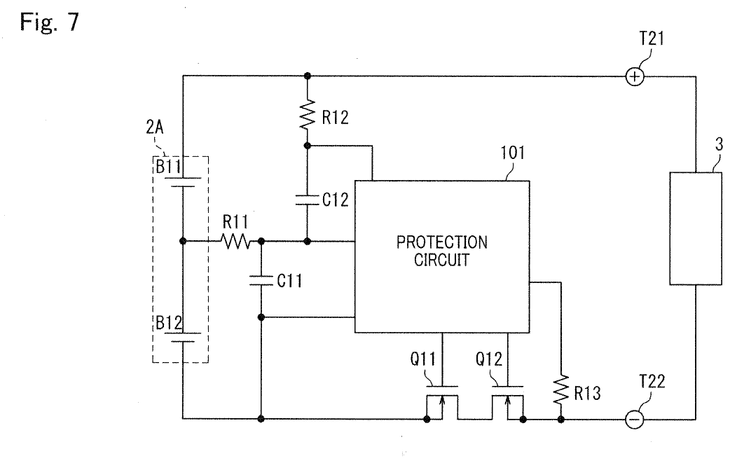

FIG. 8 is a block diagram illustrating a configuration example of a protection circuit for a secondary battery according to a conventional example 2 and its peripheral circuits.

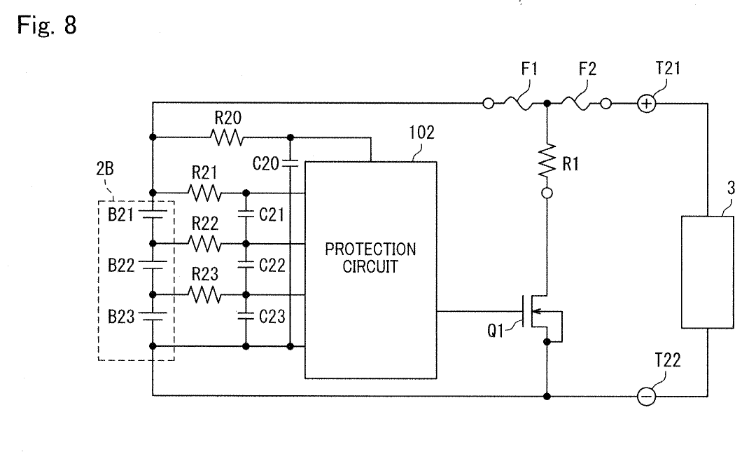

### DETAILED DESCRIPTION

Hereinafter, embodiments and modified embodiments according to the present invention will be described with reference to the drawings. It is to be noted that the same or similar components are denoted by the same reference numerals.

### Embodiment 1

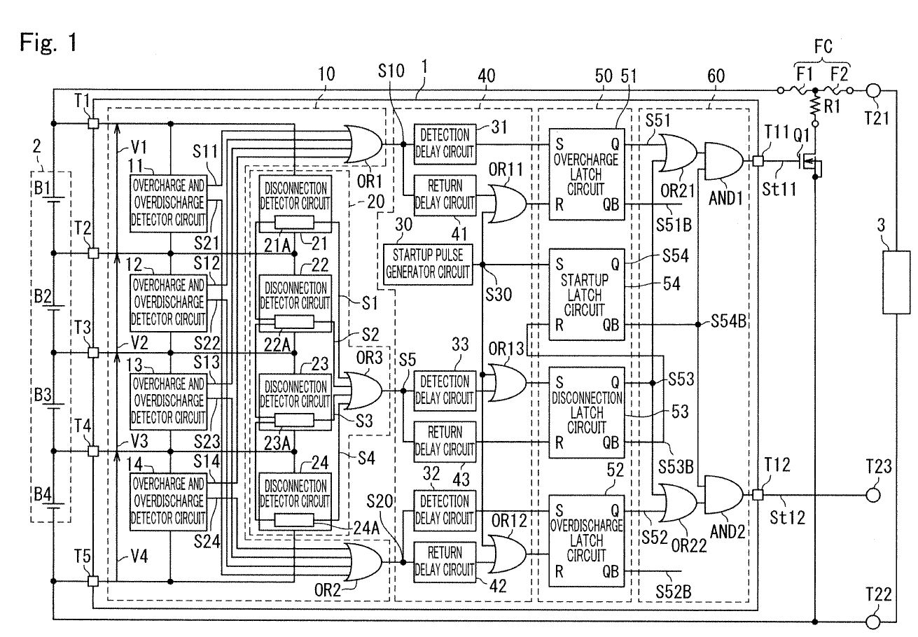

FIG. 1 is a block diagram illustrating a configuration example of a protection circuit 1 for a secondary battery (hereinafter, referred to as a protection circuit) according to an embodiment 1 and its peripheral circuits.

Referring to FIG. 1, the protection circuit 1 includes, for example, a semiconductor IC, and monitors voltages V1 to V4 of, for example, four secondary batteries B1 to B4 connected in series to detect:
(1) an overcharged state of each of the secondary batteries B1 to B4;
(2) an overdischarge state of each of the secondary batteries B1 to B4; and
(3) a disconnection state between each of the secondary batteries B1 to B4 and the protection circuit 1.

In this case, the protection circuit 1 is set not to detect the overcharge state and the overdischarge state of the secondary battery in the disconnection state at the time of initial connection (this time is referred to as the time when the protection circuit 1 is connected to some terminals of the secondary batteries. Since the power to the protection circuit 1 is supplied from the secondary batteries B1 to B4, the startup of the protection circuit 1 and the connection of the secondary batteries B1 to B4 are substantially simultaneously done). On the other hand, the protection circuit 1 is set to detect the overcharge state and the overdischarge state of the secondary battery when the secondary battery is not in the disconnection state at the time of initial connection (alternatively, referred to as the time when the disconnection state disappears). Accordingly, the object of the protection circuit 1 according to the embodiment 1 is to provide a protection function by preventing erroneous detection on the way of connections at the time of startup and by detecting disconnection after connection.

In this case, an assembled battery 2 configured to include the four secondary batteries B1 to B4 is connected to, for example, a load of an electronic apparatus or a charging apparatus 3 via a fuse circuit FC and terminals T21 and T22. The protection circuit 1 generates a protection signal St11 having the H level to turn on a switch MOS transistor Q1 during the protection operation, and fuses the fuse circuit FC including the series circuit of fuses F1 and F2 by heat generated by a heater resistor R1 to protect the load, the charging apparatus 3, or the assembled battery 2. The assembled battery 2, the protection circuit 1, the fuse circuit FC, the resistor R1, and the MOS transistor Q1 configure a battery apparatus.

The protection circuit 1 of FIG. 1 has input terminals T1 to T5 and output terminals T11 and T12. The protection circuit 1 includes an overcharge and overdischarge detector unit 10, a disconnection detector unit 20, a latch control unit 40, a latch circuit unit 50, and a protection logic circuit unit 60. In this case, the overcharge and overdischarge detector unit 10 includes four overcharge and overdischarge detector circuits 11 to 14, and two OR-gates OR1 and OR2. The disconnection detector unit 20 includes four disconnection detector circuits 21 to 24, and an OR-gate OR3. The latch control unit 40 includes a startup pulse generator circuit 30, three detection delay circuits 31 to 33, three return delay circuits 41 to 43, and three OR-gates OR11 to OR13. The latch circuit unit 50 includes an overcharge latch circuit 51, an overdischarge latch circuit 52, a disconnection latch circuit 53, and a startup latch circuit 54. The protection logic circuit unit 60 includes two OR-gates OR21 and OR22, and two AND-gates AND1 and AND2.

The positive electrode of the secondary battery B1 (that is, the positive electrode of the assembled battery 2) is connected to the load of the electronic apparatus or the charging apparatus 3 via the fuse circuit FC and the external terminal T21, and is also connected to the positive electrode terminals of the overcharge and overdischarge detector circuit 11 and the disconnection detector circuit 21 via the input terminal T1. The negative electrode of the secondary battery B1 and the positive electrode of the secondary battery B2 are connected to each other, and connected to the negative electrode terminals of the overcharge and overdischarge detector circuit 11 and the disconnection detector circuit 21 and the positive electrode terminals of the overcharge and overdischarge detector circuit 12 and the disconnection detector circuit 22, via the input terminal T2. The negative electrode of the secondary battery B2 and the positive electrode of the secondary battery B3 are connected to each other, and connected to the negative electrode terminals of the overcharge and overdischarge detector circuit 12 and the disconnection detector circuit 22 and the positive electrode terminals of the overcharge and overdischarge detector circuit 13 and the disconnection detector circuit 23, via the input terminal T3. The negative electrode of the secondary battery B3 and the positive electrode of the secondary battery B4 are connected to each other, and connected to the negative electrode terminals of the overcharge and overdischarge detector circuit 13 and the disconnection detector circuit 23 and the positive electrode terminals of the overcharge and overdischarge detector circuit 14 and the disconnection detector circuit 24, via the input terminal T4. The negative electrode of the secondary battery B4 (that is, the negative electrode of the assembled battery 2) is connected to the load of the electronic apparatus or the charging apparatus 3 via the external terminal T22, and is also connected to the negative electrode terminals of the overcharge and overdischarge detector circuit 14 and the disconnection detector circuit 24, via the input terminal T5.

The overcharge and overdischarge detector circuit 11 performs an overcharge detection process and an overdischarge detection process based on the input voltage V1. The overcharge and overdischarge detector circuit 11 generates an overcharge detection signal S11 having the H level when the input voltage V1≥Vthc (overcharge detection threshold value), and generates the overcharge detection signal S11 having the L level when the input voltage V1<Vthc. The overcharge detection signal S11 is output as an overcharge detection signal S10 to the detection delay circuit 31 and the return delay circuit 41 via the OR-gate OR1. The overcharge and overdischarge detector circuit 11 generates an overdischarge detection signal S21 having the H level when the input voltage V1≤Vthd (overdischarge detection threshold value; Vthd<Vthc), and generates the overdischarge detection signal S21 having the L level when the input voltage V1>Vthd. The overdischarge detection signal S21 is output as an overdischarge detection signal S20 to the detection delay circuit 32 and the return delay circuit 42 via the OR-gate OR2.

The overcharge and overdischarge detector circuit 12 performs an overcharge detection process and an overdischarge detection process based on the input voltage V2. The overcharge and overdischarge detector circuit 12 generates an overcharge detection signal S12 having the H level when the input voltage V2≥Vthc (overcharge detection threshold value), and generates the overcharge detection signal S12 having the L level when the input voltage V2<Vthc. The overcharge detection signal S12 is output as an overcharge detection signal S10 to the detection delay circuit 31 and the return delay circuit 41 via the OR-gate OR1. The overcharge and overdischarge detector circuit 12 generates an overdischarge detection signal S22 having the H level when the input voltage V2≤Vthd (overdischarge detection threshold value), and generates the overdischarge detection signal S22 having the L level when the input voltage V2>Vthd. The overdischarge detection signal S22 is output as an overdischarge detection signal S20 to the detection delay circuit 32 and the return delay circuit 42 via the OR-gate OR2.

The overcharge and overdischarge detector circuit 13 performs an overcharge detection process and an overdischarge detection process based on the input voltage V3. The overcharge and overdischarge detector circuit 13 generates an overcharge detection signal S13 having the H level when the input voltage V3≥Vthc (overcharge detection threshold value), and generates the overcharge detection signal S13 having the L level when the input voltage V3<Vthc. The overcharge detection signal S13 is output as an overcharge detection signal S10 to the detection delay circuit 31 and the return delay circuit 41 via the OR-gate OR1. The overcharge and overdischarge detector circuit 13 generates an overdischarge detection signal S23 having the H level when the input voltage V3≤Vthd (overdischarge detection threshold value), and generates the overdischarge detection signal S23 having the L level when the input voltage V3>Vthd. The overdischarge detection signal S23 is output as an overdischarge detection signal S20 to the detection delay circuit 32 and the return delay circuit 42 via the OR-gate OR2.

The overcharge and overdischarge detector circuit 14 performs an overcharge detection process and an overdischarge detection process based on the input voltage V4. The overcharge and overdischarge detector circuit 14 generates an overcharge detection signal S14 having the H level when the input voltage V4≥Vthc (overcharge detection threshold value), and generates the overcharge detection signal S14 having the L level when the input voltage V4<Vthc. The overcharge detection signal S14 is output as an overcharge detection signal S10 to the detection delay circuit 31 and the return delay circuit 41 via the OR-gate OR1. The overcharge and overdischarge detector circuit 14 generates an overdischarge detection signal S24 having the H level when the input voltage V4≤Vthd (overdischarge detection threshold value), and generates the overdischarge detection signal S24 having the L level when the input voltage V4>Vthd. The overdischarge detection signal S24 is output as an overdischarge detection signal S20 to the detection delay circuit 32 and the return delay circuit 42 via the OR-gate OR2.

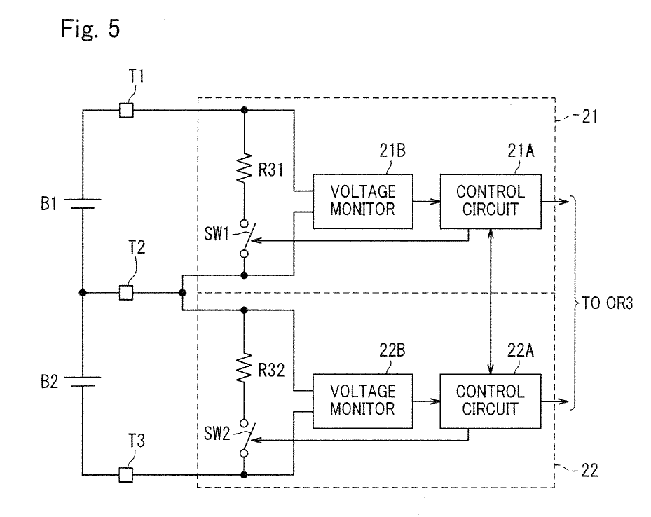

FIG. 5 is a block diagram illustrating a detailed configuration example of the disconnection detector circuits 21 and 22 of FIG. 1. It is to be noted that the disconnection detector circuits 23 to 24 are similarly configured. In this case, the disconnection detector circuits 21 to 24 includes control circuits 21A to 24A, respectively, and control signals are transmitted and received between adjacent control circuits (21A, 22A), (22A, 23A), and (23A, 24A) among the control circuits 21A to 24A.

Referring to FIG. 5, the disconnection detector circuit 21 includes a series circuit of a resistor R31 and a switch SW1 connected between the input terminals T1 and T2, the voltage monitor 21B, and the control circuit 21A. The voltage monitor 21B detects a voltage between the input terminals T1 and T2, and outputs the detected voltage to the control circuit 21A. By performing the following first and second disconnection detection operations, the control circuit 21A transmits and receives control signals to and from the control circuit 22A of the disconnection detector circuit 22 to control the switches SW1 and SW2, and performs a disconnection detection process on whether or not the line connected to the input terminal T1 or T2 is disconnected based on the detection voltage of the voltage monitor 21B.

The disconnection detector circuit 22 includes a series circuit of a resistor R32 and the switch SW2 connected between the input terminals T2 and T3, a voltage monitor 22B, and the control circuit 22A. The voltage monitor 22B detects a voltage between the input terminals T2 and T3, and outputs the detected voltage to the control circuit 22A. By performing the following first and second disconnection detection operations, the control circuit 22A transmits and receives control signals to and from the control circuit 21A of the disconnection detector circuit 21 to control the switches SW1 and SW2, and performs a disconnection detection process on whether or not the line connected to the input terminal T2 or T3 is disconnected based on the detection voltage of the voltage monitor 22B.

In this case, the switches SW1 and SW2 are turned off in the normal state.

### (1) First Disconnection Detection Operation

In this case, the control circuit 21A turns on the switch SW1, and the control circuit 22A turns off the switch SW2. When the line connected to the input terminal T1 is disconnected, the voltage potential of the input terminal T1 approaches the voltage potential of the input terminal T2, so that the voltage input to the voltage monitor 21B decreases. When the detection voltage of the voltage monitor 21B falls below a predetermined disconnection detection threshold voltage (for example, a positive voltage near zero V such as 0.1 V), it is determined that the line connected to the input terminal T1 is disconnected (disconnection detection). On the other hand, when the line connected to the input terminal T2 is disconnected, the voltage potential of the input terminal T2 approaches the voltage potential of the input terminal T1, so that the voltage input to the voltage monitor 21B decreases. When the voltage falls below a predetermined disconnection detection threshold voltage (for example, a positive voltage near zero V such as 0.1 V) of the voltage monitor 21B, it is determined that the line connected to the input terminal T2 is disconnected (disconnection detection).

### (2) Second Disconnection Detection Operation

In this case, the control circuit 21A turns off the switch SW1, and the control circuit 22A turns on the switch SW2. When the line connected to the input terminal T2 is disconnected, the voltage potential of the input terminal T2 approaches the voltage potential of the input terminal T3, so that the voltage input to the voltage monitor 22B decreases. When the detection voltage of the voltage monitor 22B falls below a predetermined disconnection detection threshold voltage (for example, a positive voltage near zero V such as 0.1 V), it is determined that the line connected to the input terminal T2 is disconnected (disconnection detection). On the other hand, when the line connected to the input terminal T3 is disconnected, the voltage potential of the input terminal T3 approaches the voltage potential of the input terminal T2, so that the voltage input to the voltage monitor 22B decreases. When the voltage falls below a predetermined disconnection detection threshold voltage (for example, a positive voltage near zero V such as 0.1 V) of the voltage monitor 22B, it is determined that the line connected to the input terminal T3 is disconnected (disconnection detection).

It is to be noted that the disconnection detector circuits 23 to 24 are configured and operate in a manner similar to those of the disconnection detector circuits 21 to 22. In this case, each of the disconnection detector circuits 21 to 24 operates as follows at the time of disconnection detection and at the time of non-disconnection detection.

The disconnection detector circuit 21 generates a disconnection detection signal S1 having the H level at the time of disconnection detection, and generates a disconnection detection signal S1 having the L level at the time of non-disconnection detection. The disconnection detection signal S1 is output as a disconnection detection signal S5 to the detection delay circuit 33 and the return delay circuit 43 via the OR-gate OR3.

The disconnection detector circuit 22 generates a disconnection detection signal S2 having the H level at the time of disconnection detection, and generates the disconnection detection signal S2 having the L level at the time of non-disconnection detection. The disconnection detection signal S2 is output as a disconnection detection signal S5 to the detection delay circuit 33 and the return delay circuit 43 via the OR-gate OR3.

The disconnection detector circuit 23 generates a disconnection detection signal S3 having the H level at the time of disconnection detection, and generates the disconnection detection signal S3 having the L level at the time of non-disconnection detection. The disconnection detection signal S3 is output as a disconnection detection signal S5 to the detection delay circuit 33 and the return delay circuit 43 via the OR-gate OR3.

The disconnection detector circuit 24 generates a disconnection detection signal S4 having the H level at the time of disconnection detection, and generates the disconnection detection signal S4 having the L level at the time of non-disconnection detection. The disconnection detection signal S4 is output as a disconnection detection signal S5 to the detection delay circuit 33 and the return delay circuit 43 via the OR-gate OR3.

When at least two terminals of the input terminals T1 to T5 are connected to the secondary batteries B1 to B4 so that the power supply to the protection circuit 1 is turned on and the protection circuit 1 is activated, the startup pulse generator circuit 30 generates a startup pulse signal S30 having the H level that is a one-shot pulse, outputs the generated signal S30 to the reset terminal of the overcharge latch circuit 51 via the OR-gate OR11, outputs the signal S30 to the reset terminal of the overdischarge latch circuit 52 via the OR-gate OR12, and outputs the signal S30 to the set terminal of the disconnection latch circuit 53 via the OR-gate OR13.

The detection delay circuit 31 delays the input overcharge detection signal S10 by a predetermined delay time TM1, and then outputs the signal S10 to the set terminal of the overcharge latch circuit 51. The return delay circuit 41 delays the input overcharge detection signal S10 by a predetermined delay time TM2, and then outputs the signal to the reset terminal of the overcharge latch circuit 51 via the OR-gate OR11.

The detection delay circuit 32 delays the input overdischarge detection signal S20 by a predetermined delay time TM11, and then outputs the signal to the set terminal of the overdischarge latch circuit 52. The return delay circuit 42 delays the input overdischarge detection signal S20 by a predetermined delay time TM12, and then outputs the signal S20 to the reset terminal of the overdischarge latch circuit 52 via the OR-gate OR12.

The detection delay circuit 33 delays the input disconnection detection signal S5 by a predetermined delay time TM21, and then outputs the signal to the set terminal of the disconnection latch circuit 53 via the OR-gate OR13. The return delay circuit 43 delays the input disconnection detection signal S5 by a predetermined delay time TM22, and then outputs the signal to the reset terminal of the disconnection latch circuit 53.

It is to be noted that the delay times TM1, TM11, and TM21 by the detection delay circuits 31 to 33 and the delay times TM2, TM12, and TM22 by the return delay circuits 41 to 43 may not be provided. With the configuration as in the present embodiment, it is possible to prevent erroneous detection of the overcharge detection signal S10, the overdischarge detection signal S20, and the disconnection detection signal S5 due to noise or the like of the power supply to the protection circuit 1 at the time of charging and discharging the secondary battery.

Each of the overcharge latch circuit 51, the overdischarge latch circuit 52, the disconnection latch circuit 53, and the startup latch circuit 54 includes a set reset (SR) latch circuit. Each of the latch circuits 51 to 54 latches the binary signal of the value having the H level “1” in response to the signal having the H level input to the set terminal, outputs the binary signals S51 to S54 each having the H level from the output terminal Q, and outputs the inverted binary signals S51B to S54B each having the L level from the inverting output terminal QB. In response to the signal input having the H level to the reset terminal, each of the latch circuits 51 to 54 resets the latched binary signal to the binary signal having the L level, outputs the binary signal having the L level from the output terminal Q, and outputs the inverted binary signals S51B to S54B having the H level from the inverting output terminal QB.

The binary signal S51 from the overcharge latch circuit 51 is input to the gate of the switch MOS transistor Q1 as the protection control signal St11 via the OR-gate OR21, the AND-gate AND1, and the output terminal T11. The binary signal S52 from the overdischarge latch circuit 52 is output to the external terminal T23 as the protection control signal St12 via the OR-gate OR22, the AND-gate AND2, and the output terminal T12. The inverted binary signal S53B from the disconnection latch circuit 53 is output to the reset terminal of the startup latch circuit 54. The inverted binary signal S54B from the startup latch circuit 54 is output to the gate of the switch MOS transistor Q1 via the AND-gate AND1 and the output terminal T11, and is output to the external terminal T23 via the AND-gate AND2 and the output terminal T12.

The protection circuit 1 configured as described above includes:
(1) a function (the disconnection detector unit 20) of detecting a disconnection between each of the secondary batteries B1 to B4 and the protection circuit 1;
(2) a function (the overcharge and overdischarge detector unit 10) of detecting an overcharge state of each of the secondary batteries B1 to B4; and
(3) a function (the overcharge and overdischarge detector unit 10) of detecting an overdischarge state of each of the secondary batteries B1 to B4.

The overcharge detection signal S10, the overdischarge detection signal S20, and the disconnection detection signal S5, which are the detection signals, are output via the latch control unit 40, the latch circuit unit 50, and the protection logic circuit unit 60. In this case, at the time of overcharge detection or disconnection detection, the protection logic circuit unit 60 generates the protection signal St11 having the H level to turn on the switch MOS transistor Q1, and fuses the fuse circuit FC including the series circuit of the fuses F1 and F2 by heat generated by the heater resistor R1 to protect the load or charging apparatus 3 or the assembled battery 2.

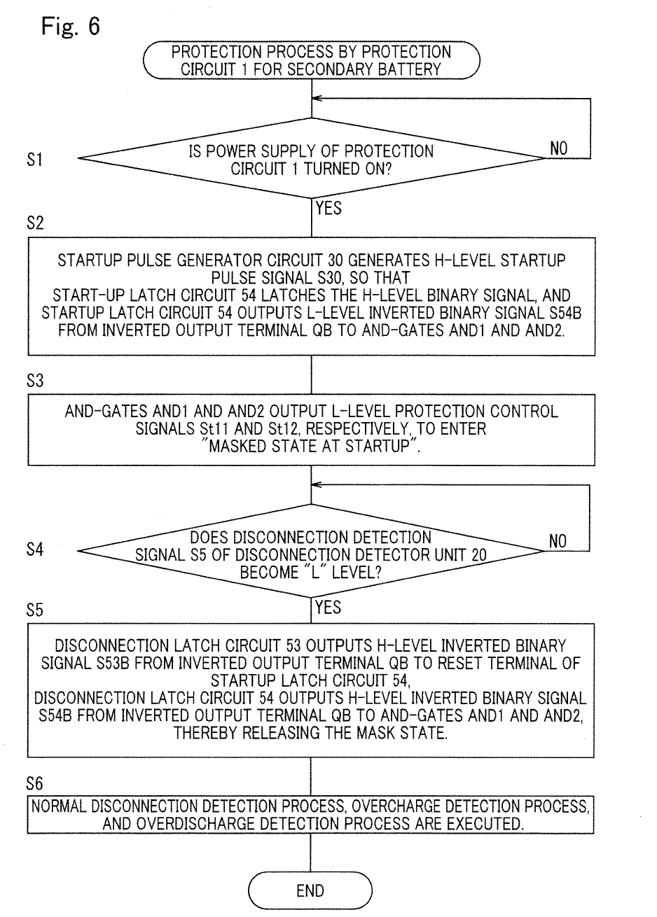

FIG. 6 is a flowchart illustrating a protection process executed by the protection circuit 1 for the secondary battery of FIG. 1. With reference to FIG. 6, the protection process of this embodiment will be described below.

The protection circuit 1 includes the startup latch circuit 54 that generates and latches the startup pulse signal S30 at the time of startup, and generates and outputs a binary signal S54 having the H level and an inverted binary signal S54B having the L level.

In this case, when the protection circuit 1 in which the power supply to the protection circuit 1 is turned on is activated (YES in S1), the startup pulse signal S30 having the H level is generated from the startup pulse generator circuit 30. As a result, the startup latch circuit 54 latches the binary signal having the H level, and outputs the inverted binary signal S54B having the L level from the inverting output terminal QB of the startup latch circuit 54 to the AND-gates AND1 and AND2 (S2). In this case, when the inverted binary signal S54B having the L level is input to each of the AND-gates AND1 and AND2, the protection control signals St11 and St12 having the L level are output from the AND-gates AND1 and AND2. Thus, by the AND-gates AND1 and AND2, the protection function in which the protection control signals St11 and St12 have the H level becomes invalid, and a “mask state at the time of startup” is established (S3).

Next, when the secondary batteries B1 to B4 are connected to all the input terminals T1 to T5, the disconnection detection signal S5 having the L level from the disconnection detector unit 20 is input to the return delay circuit 43 of the latch control unit 40, and the signal having the H level is input to the reset terminal of the disconnection latch circuit 53. Then, the disconnection detection state is returned (YES in S4), and the inverted binary signal S53B having the H level is input to the reset terminal of the startup latch circuit 54, and the startup latch circuit 54 is reset. As a result, the inverted binary signal S54B having the H level from the startup latch circuit 54 is input to the AND-gates AND1 and AND2. Then, the mask is released (S5), and the protection control signals St11 and St12 having the H level based on the disconnection detection signal S5 and the overcharge detection signal S10 or the overdischarge detection signal S20 can be output from the output terminals T11 and T12 which are the charge and discharge control terminals, and the protection function becomes effective. Thereafter, a normal disconnection detection process, an overcharge detection process, and an overdischarge detection process are executed (S6).

Therefore, according to the embodiment 1, the erroneous detection due to the disconnection detection, the overcharge detection, and the overdischarge detection does not occur during the startup of the protection circuit 1, and the protection function by the disconnection detection, the overcharge detection, and the overdischarge detection becomes effective in the normal state. As a result, it is possible to provide the protection circuit for the secondary battery capable of achieving both erroneous detection on the way of connections at the time of startup and a protection function by detection of disconnection after connection.

In the embodiment 1, the control circuit including the latch control unit 40, the latch circuit unit 50, and the protection logic circuit unit 60 is an example of a “protection control circuit” that executes a protection process by preventing erroneous detection on the way of connections at the time of startup and detecting disconnection after connection.

### Embodiment 2

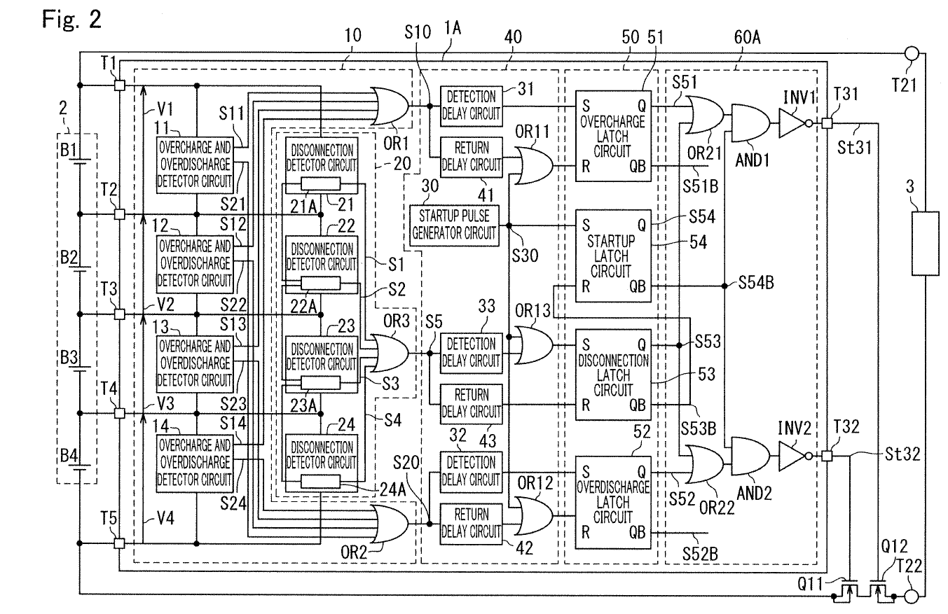

FIG. 2 is a block diagram illustrating a configuration example of a protection circuit 1A for a secondary battery according to an embodiment 2 and its peripheral circuits. Referring to FIG. 2, the protection circuit 1A for the secondary battery according to the embodiment 2 and its peripheral circuits are different from the protection circuit 1 of FIG. 1 and its peripheral circuits in the following points.

(1) The protection circuit 1A includes a protection logic circuit unit 60A instead of the protection logic circuit unit 60. As compared with the protection logic circuit unit 60, the protection logic circuit unit 60A further includes inverters INV1 and INV2, and includes output terminals T31 and T32 instead of the output terminals T11 and T12.

(2) The peripheral circuits of the protection circuit 1A include charge and discharge switch MOS transistors (hereinafter, referred to as MOS transistors) Q11 and Q12 instead of the fuse circuit FC, the resistor R1, and the switch MOS transistor Q1.

Differences will be described below.

Referring to FIG. 2, the protection logic circuit unit 60A generates a protection signal St31 having the L level and turns off the MOS transistor Q12 at the time of overcharge detection or disconnection detection via the output terminal T31 to protect the load or charging apparatus 3, or the assembled battery 2. In addition, the protection logic circuit unit 60A generates a protection signal St32 having the L level and turns off the MOS transistor Q11 via the output terminal T32 at the time of overdischarge detection or disconnection detection to protect the load, the charging apparatus 3, or the assembled battery 2. As a result, a “temporary protection process” is performed on the load or charging apparatus 3, or the assembled battery 2.

The protection circuit 1A configured as described above has the same action and effects as those of the protection circuit 1 except that the “temporary protection process” is performed.

Therefore, according to the embodiment 2, the erroneous detection due to the disconnection detection, the overcharge detection, and the overdischarge detection does not occur during the startup of the protection circuit 1A, and the protection function by the disconnection detection, the overcharge detection, and the overdischarge detection becomes effective in the normal state. As a result, it is possible to provide the protection circuit for the secondary battery capable of achieving both erroneous detection on the way of connections at the time of startup and a protection function by detection of disconnection after connection.

In the embodiment 2, the control circuit including the latch control unit 40, the latch circuit unit 50, and the protection logic circuit unit 60A is an example of a “protection control circuit” that executes erroneous detection prevention on the way of connections at the time of startup, protection process by detection of disconnection after connection, and the “temporary protection process”.

### Embodiment 3

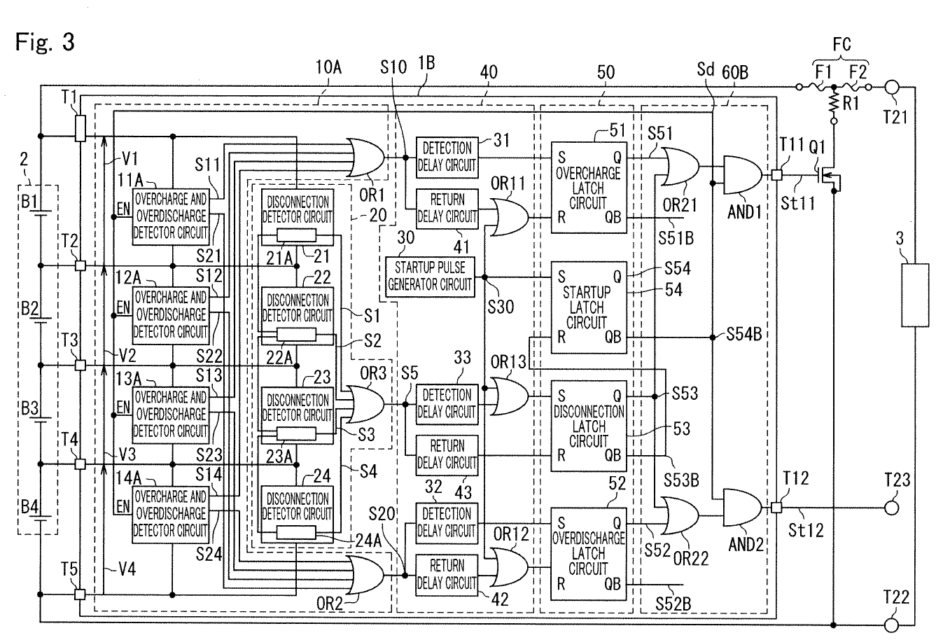

FIG. 3 is a block diagram illustrating a configuration example of a protection circuit 1B for a secondary battery according to an embodiment 3 and its peripheral circuits. Referring to FIG. 3, the protection circuit 1B for the secondary battery according to the embodiment 3 and its peripheral circuits are different from the protection circuit 1 of FIG. 1 and its peripheral circuits in the following points.

(1) The protection circuit 1B includes an overcharge and overdischarge detector unit 10A instead of the overcharge and overdischarge detector unit 10.

(2) As compared with the overcharge and overdischarge detector unit 10, the overcharge and overdischarge detector unit 10A includes overcharge and overdischarge detector circuits 11A to 14A instead of the overcharge and overdischarge detector circuits 11 to 14. The overcharge and overdischarge detector circuits 11A to 14A further include an enable terminal EN to which an enable signal or a disable signal for selectively switching an operation state thereof between “operation” and “non-operation” is input.

(3) The protection logic circuit unit 60 is replaced with a protection logic circuit unit 60B. In the protection logic circuit unit 60B, the inverted binary signal S54B from the startup latch circuit 54 is input to the enable terminal EN of each of the overcharge and overdischarge detector circuits 11A to 14A as a disable signal Sd.

Differences will be described below.

Referring to FIG. 3, when the “mask state at the time of startup” (S3 in FIG. 6) is established, the inverted binary signal S54B having the L level is input as the disable signal Sd to the enable terminal EN of each of the overcharge and overdischarge detector circuits 11A to 14A. Therefore, the operations of the overcharge and overdischarge detector circuits 11A to 14A can be stopped on the way of the connections at the time of startup. As a result, it is possible to prevent an erroneous operation in the overcharge detection process and the overdischarge detection process by the overcharge and overdischarge detector circuits 11A to 14A on the way of the connections at the time of startup.

The protection circuit 1B configured as described above has the same action and effects as those of the protection circuit 1 except that the operations of the overcharge and overdischarge detector circuits 11A to 14A are stopped on the way of the connections at the time of startup.

Therefore, according to the embodiment 3, the erroneous detection due to the disconnection detection, the overcharge detection, and the overdischarge detection does not occur during the startup of the protection circuit 1B, and the protection function by the disconnection detection, the overcharge detection, and the overdischarge detection becomes effective in the normal state. As a result, it is possible to provide the protection circuit for the secondary battery capable of achieving both erroneous detection on the way of connections at the time of startup and a protection function by detection of disconnection after connection.

In the embodiment 3, the control circuit including the latch control unit 40, the latch circuit unit 50, and the protection logic circuit unit 60B is an example of a “protection control circuit” that executes protection process by preventing erroneous detection on the way of connections at the time of startup and detecting disconnection after connection.

### Embodiment 4

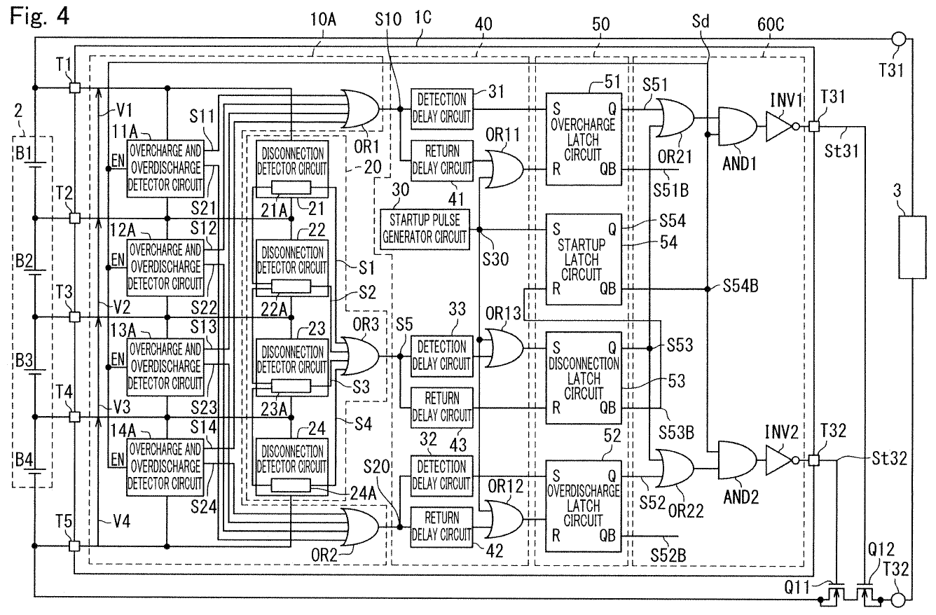

FIG. 4 is a block diagram illustrating a configuration example of a protection circuit 1C for a secondary battery according to an embodiment 4 and its peripheral circuits. Referring to FIG. 4, the protection circuit 1C for the secondary battery according to the embodiment 4 and its peripheral circuits are different from the protection circuit 1A of FIG. 2 and its peripheral circuits in the following points.

(1) The protection circuit 1C includes an overcharge and overdischarge detector unit 10A instead of the overcharge and overdischarge detector unit 10.

(2) As compared with the overcharge and overdischarge detector unit 10, the overcharge and overdischarge detector unit 10A includes overcharge and overdischarge detector circuits 11A to 14A instead of the overcharge and overdischarge detector circuits 11 to 14. The overcharge and overdischarge detector circuits 11A to 14A further include an enable terminal EN to which an enable signal or a disable signal for selectively switching an operation state thereof between “operation” and “non-operation” is input.

(3) The protection logic circuit unit 60A is replaced with a protection logic circuit unit 60C. In the protection logic circuit unit 60C, an inverted binary signal S54B from a startup latch circuit 54 is output to the enable terminal EN of each of the overcharge and overdischarge detector circuits 11A to 14A as a disable signal Sd.

Differences will be described below.

Referring to FIG. 3, when the “mask state at the time of startup” (S3 in FIG. 6) is established, the inverted binary signal S54B having the L level is input as the disable signal Sd to the enable terminal EN of each of the overcharge and overdischarge detector circuits 11A to 14A. Therefore, the operations of the overcharge and overdischarge detector circuits 11A to 14A can be stopped on the way of the connections at the time of startup. As a result, it is possible to prevent an erroneous operation in the overcharge detection process and the overdischarge detection process by the overcharge and overdischarge detector circuits 11A to 14A on the way of the connections at the time of startup.

The protection circuit 1C configured as described above has the same action and effects as those of the protection circuit 1A except that the operations of the overcharge and overdischarge detector circuits 11A to 14A are stopped on the way of the connections at the time of startup.

Therefore, according to the embodiment 4, the erroneous detection due to the disconnection detection, the overcharge detection, and the overdischarge detection does not occur during the startup of the protection circuit 1C, and the protection function by the disconnection detection, the overcharge detection, and the overdischarge detection becomes effective in the normal state. As a result, it is possible to provide the protection circuit for the secondary battery capable of achieving both erroneous detection on the way of connections at the time of startup and a protection function by detection of disconnection after connection.

In the embodiment 4, the control circuit including the latch control unit 40, the latch circuit unit 50, and the protection logic circuit unit 60C is an example of a “protection control circuit” that executes erroneous detection prevention on the way of connections at the time of startup, protection process by detection of disconnection after connection, and the “temporary protection process”.

### Modified Embodiments

In the above embodiments, the overcharge detection process and the overdischarge detection process are executed, but the present invention is not limited thereto, and at least one of the overcharge detection process and the overdischarge detection process may be executed.

### INDUSTRIAL APPLICABILITY

As described in details above, according to the protection circuit for the secondary battery according to one aspect of the present invention, by using the determination of the presence or absence of the disconnection at the time of startup of the protection circuit for the determination of whether or not the connection is in progress, it is possible to achieve both the prevention of erroneous detection on the way of the connections at the time of startup and the protection function by the disconnection detection after the connection.

### EXPLANATION OF REFERENCES

1, 1A to 1C Protection circuit for secondary battery (Protection circuit)
2, 2A, and 2B Assembled battery
3 Load or charging apparatus
10, and 10A Overcharge and overdischarge detector unit
11 to 14, and 11A to 14A Overcharge and overdischarge detector circuit
20 Disconnection detector unit
21 to 24 Disconnection detector circuit
21A to 24A Control circuit
21B to 24B Voltage monitor
30 Startup pulse generator circuit
31 to 33 Detection delay circuit
40 Latch control unit
41 to 43 Return delay circuit
50 Latch circuit unit
51 Overcharge latch circuit
52 Overdischarge latch circuit
53 Disconnection latch circuit
54 Startup latch circuit
60 to 60C Protection logic circuit unit
101 Protection circuit
102 Protection circuit
AND1 to AND2 AND-gate
B1 to B23 Secondary battery
C1 to C23 Capacitor
F1, F2 Fuse
OR1 to OR22 OR-gate
Q1 to Q12 MOS transistor
R1 to R32 Resistor
SW1, and SW2 Switch
T1 to T23 Terminal

1. A protection circuit for a secondary battery configured to protect an assembled battery including a plurality of secondary batteries connected in series by cutting a charging path to the assembled battery or a discharging path from the assembled battery, the protection circuit for the secondary battery comprising:
a first detector circuit for at least one of an overcharge detector circuit configured to detect overcharge of the plurality of secondary batteries and an overdischarge detector circuit configured to detect overdischarge from the plurality of secondary batteries, the first detector circuit being configured to output a first detection signal at a time of detection of the overcharge or the overdischarge;
a second detector circuit configured to detect disconnection between the plurality of secondary batteries and the protection circuit, and output a second detection signal at a time of detection of the disconnection; and
a protection control circuit configured to stop cutting of the charging path or the discharging path based on the first and second detection signals until the disconnection is no longer detected after startup of the protection circuit.

2. A protection circuit for a secondary battery configured to protect an assembled battery including a plurality of secondary batteries connected in series by cutting a charging path to the assembled battery or a discharging path from the assembled battery, the circuit for the secondary battery comprising:
a first detector circuit for at least one of an overcharge detector circuit configured to detect overcharge of the plurality of secondary batteries and an overdischarge detector circuit configured to detect overdischarge from the plurality of secondary batteries, the first detector circuit being configured to output a first detection signal at a time of detection of the overcharge or the overdischarge;
a second detector circuit configured to detect disconnection between the plurality of secondary batteries and the protection circuit, and output a second detection signal at a time of detection of the disconnection; and
a protection control circuit configured to stop a detection operation of the first detector circuit and stop cutting of the charging path or the discharging path based on the second detection signal until the disconnection is no longer detected after startup of the protection circuit.

3. The protection circuit for the secondary battery as claimed in claim 1,
wherein the protection control circuit protects the assembled battery by fusing a fuse circuit of the charging path or the discharging path.

4. The protection circuit for the secondary battery as claimed in claim 1,
wherein the protection control circuit protects the assembled battery by turning off a switch transistor of the charging path or the discharging path.

5. A protection method for a secondary battery, the protection method being provided for a protection circuit configured to protect an assembled battery including a plurality of secondary batteries connected in series by cutting a charging path to the assembled battery or a discharging path from the assembled battery,
wherein the protection circuit includes:
a first detector circuit for at least one of an overcharge detector circuit configured to detect overcharge of the plurality of secondary batteries and an overdischarge detector circuit configured to detect overdischarge from the plurality of secondary batteries, the first detector circuit being configured to output a first detection signal at a time of detection of the overcharge or the overdischarge; and
a second detector circuit configured to detect disconnection between the plurality of secondary batteries and the protection circuit, and output a second detection signal at a time of detection of the disconnection, and
wherein the protection method comprises:
by the protection control circuit, stopping cutting of the charging path or the discharging path based on the first and second detection signals until the disconnection is no longer detected after startup of the protection circuit.

6. A protection method for a secondary battery, the protection method being provided for a protection circuit that protects an assembled battery including a plurality of secondary batteries connected in series by cutting a charging path to the assembled battery or a discharging path from the assembled battery,
wherein the protection circuit includes:
a first detector circuit for at least one of an overcharge detector circuit configured to detects overcharge of the plurality of secondary batteries and an overdischarge detector circuit configured to detect overdischarge from the plurality of secondary batteries, the first detector circuit being configured to output a first detection signal at a time of detection of the overcharge or the overdischarge; and
a second detector circuit configured to detect disconnection between the plurality of secondary batteries and the protection circuit, and output a second detection signal at a time of detection of the disconnection, and
wherein the protection method comprises:
by the protection control circuit, stopping a detection operation of the first detector circuit and stopping cutting of the charging path or the discharging path based on the second detection signal until the disconnection is no longer detected after startup of the protection circuit.

7. The protection method for the secondary battery as claimed in claim 5, further comprising:
by the protection control circuit, protecting the assembled battery by fusing a fuse circuit of the charging path or the discharging path.

8. The protection method for the secondary battery as claimed in claim 5, further comprising:
by the protection control circuit, protecting the assembled battery by turning off a switch transistor of the charging path or the discharging path.

9. The protection method for the secondary battery as claimed in claim 6, further comprising:
by the protection control circuit, protecting the assembled battery by fusing a fuse circuit of the charging path or the discharging path.

10. The protection method for the secondary battery as claimed in claim 6, further comprising:
by the protection control circuit, protecting the assembled battery by turning off a switch transistor of the charging path or the discharging path.

11. The protection circuit for the secondary battery as claimed in claim 2,
wherein the protection control circuit protects the assembled battery by fusing a fuse circuit of the charging path or the discharging path.

12. The protection circuit for the secondary battery as claimed in claim 2,
wherein the protection control circuit protects the assembled battery by turning off a switch transistor of the charging path or the discharging path.
